(19) United States
(12) Patent Application Publication
(10) Pub. No.: US 2004/0250602 A1
(43) Pub. Date: Dec. 16, 2004

(54) Sensor assembly operating at high temperature and method of mounting same

(76) Inventors: Bertrand Leverrier, 26120 Montelier (FR); Claude Julien, 26500 Bourg Les Valence (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/489,784

(22) PCT Filed: Oct. 15, 2002
(86) PCT No.: PCT/FR02/03523

(30) Foreign Application Priority Data
Oct. 23, 2001 (FR) 01/13667

(51) Int. Cl. G01N 9/00

(52) U.S. Cl. 73/31.05

(57) ABSTRACT

The invention relates to sensors of physical quantities operating at high temperature, such as the sensors that can be used to measure pressure inside internal combustion engines in vehicles, aircraft or even rockets.

The sensor (10) is a micromachined sensor comprising at least one wafer (22) provided with electrical connection pads (18). To mount this sensor in a sealed manner in a wall feedthrough capable of being raised to a high temperature of about 200° C. or higher, the sensor is connected to the end of a cable (30) resistant to this high temperature, the cable comprising several electrical conductors (36) embedded in an insulation (34) held within a sheath (32), the sheath passing through the wall feedthrough, the electrical conductors extending beyond the end of the sheath and being welded directly to the pads on the wafer (22). The sheath is mounted in a sealed manner in the wall feedthrough.

The invention relates to sensors of physical quantities operating at high temperature, such as the sensors that can be used to measure pressure inside internal combustion engines in vehicles, aircraft or even rockets.

The high temperatures involved are temperatures of around 200° C., or even several hundred degrees Celsius.

Because of the difficult environment in which these sensors have to work, it is necessary to devise not only a sensor structure well suited to these conditions, but also a means of mounting the sensor in the region where the physical quantity has to be measured and a means for transmitting the measurements made out of this region.

The invention will be described with regard to a typical application, this being the measurement of pressure in a combustion chamber of an internal combustion engine, it being understood that the invention is applicable to other sensors and other applications in which the difficult environmental conditions make the invention advantageous.

To measure the pressure in a combustion chamber, the active part of the sensor must be placed in the high-temperature chamber (the temperature being, for example, about 500° C.), but of course the aim is to transmit the measurement, in the form of an electrical signal representing this measurement, to the outside of the chamber. Feedthroughs in the wall forming the boundary of the chamber are therefore necessary in order to take the electrical conductors transmitting the measurement signal from the chamber to the outside. Moreover, the sensor, in order to be able to deliver an electrical measurement signal, will usually have to have an electrical power supply. Feedthroughs in the wall are also needed for bringing the supply conductors from the outside into the chamber.

Outside the wall of the chamber, the conductors must be connected to one or more transmission cables that connect the sensor, on the one hand, to a power supply and, on the other hand, to an instrument for exploiting the measurement signal (typically, this instrument is a computer capable of reading and interpreting the voltage level that is present on the output conductors of the sensor).

The problem that arises is therefore how to mount the sensor in the wall with its active part inside the chamber and how to produce feedthroughs for the supply and output conductors.

The problem is particularly crucial when the wall of the chamber is thin and, as a consequence, the temperature of the wall outside the chamber remains very high.

The current solutions use metal cases provided with sockets fitted with glass/metal or ceramic/metal feedthroughs that bring the actual sensor on one side of the socket into communication with connection pins on the other side. These casings are expensive and bulky. For the thin walls mentioned above, that do not have a cold source on the outside of the wall (aircraft engines), the external pins must be connected to a high-temperature cable. The whole assembly is expensive and bulky.

For this reason, the present invention proposes, firstly, an assembly formed from a sensor of a physical quantity and from a cable resistant to high temperatures and, secondly, a method of mounting it.

The assembly formed from a sensor of a physical quantity and from a cable according to the invention, is characterized in that the cable comprises several electrical conductors embedded in an insulating material resistant to high temperatures and a metal sheath enclosing the conductors and the insulating material, this sheath also being resistant to high temperatures, the ends of the conductors extending beyond the insulating material at the end of the cable and being directly welded to input/output and supply contact pads on a micromachined chip forming the actual sensor.

The mounting method according to the invention is a method of mounting a sensor of a physical quantity in a sealed manner in a wall feedthrough capable of being raised to a high temperature of around 200° C. or higher, the sensor being a micromachined sensor comprising at least one wafer provided with electrical connection pads, characterized in that:

the sensor is connected to the end of a cable resistant to this high temperature, the cable comprising several electrical conductors embedded in an insulation that is held within a sheath, the sheath passing through the wall feedthrough, the electrical conductors extending beyond the end of the sheath and being welded directly to the pads on the wafer; and

the sheath is made to pass through the wall feedthrough, ensuring that the chamber is sealed at the point of the feedthrough.

The invention therefore consists in welding the contact pads of a micromachined sensor directly to the conducting ends of a multiconductor connection cable (that measures at least several centimeters or several tens of centimeters in length, the length being dictated by the application) and in fitting the sensor at the desired point, especially in a high-pressure and/or high-temperature chamber, the connection cable then passing through a wall of the chamber.

The metal sheath itself may be surrounded locally, at the place that will correspond to the feedthrough in the wall of a chamber in which the physical quantity is measured, by another sheath tightly gripping the first sheath. This second sheath will seal the wall feedthrough.

The sensor and part of the high-temperature-resistant cable will be placed inside the chamber; another part of the cable will be in the wall feedthrough, and finally the rest of the cable will be outside the chamber and will extend at least over the entire distance along which a cable resistant to high temperatures is necessary owing to the temperature of the wall outside the chamber (for example several tens of centimeters).

The insulating material constituting the cable is preferably a mineral material; this may be magnesia.

The sensor is preferably a micromachined silicon pressure sensor, the active part of which is a silicon membrane.

The electrical conductors are preferably welded to the pads on the sensor by electrolytic welding, that is to say by deposition of metal by immersion of the pads and of the ends of the conductors in an ionized solution containing this metal, with or without the presence of an electrical current.

Other features and advantages of the invention will become apparent from reading the following detailed description given with reference to the appended drawings in which:

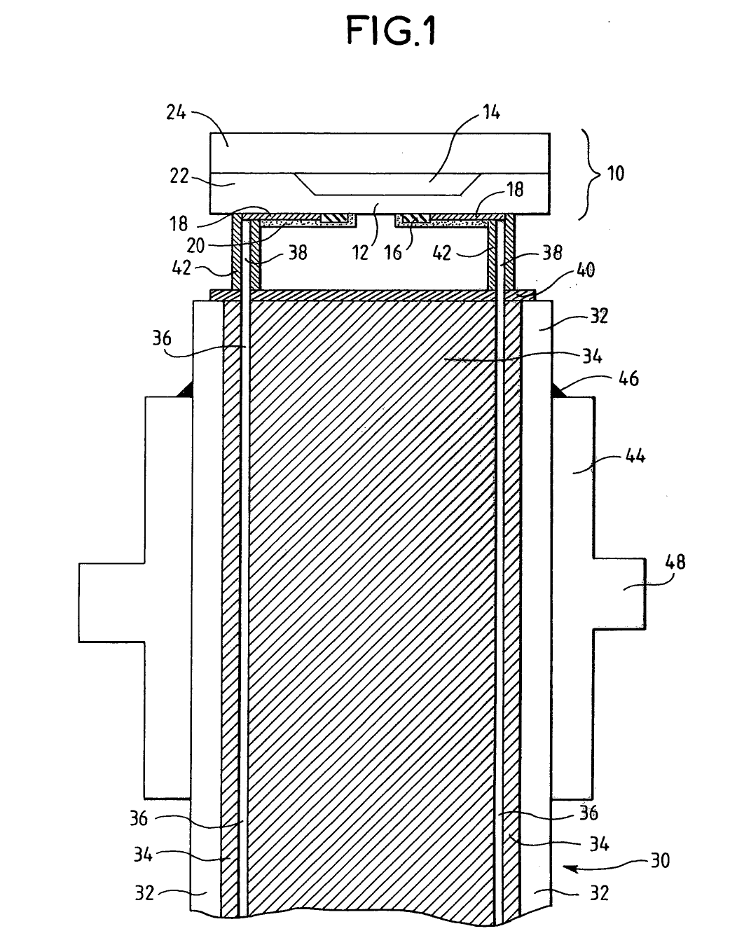

FIG. 1 shows a cross section of an assembly formed from a cable and from a sensor according to the invention; and

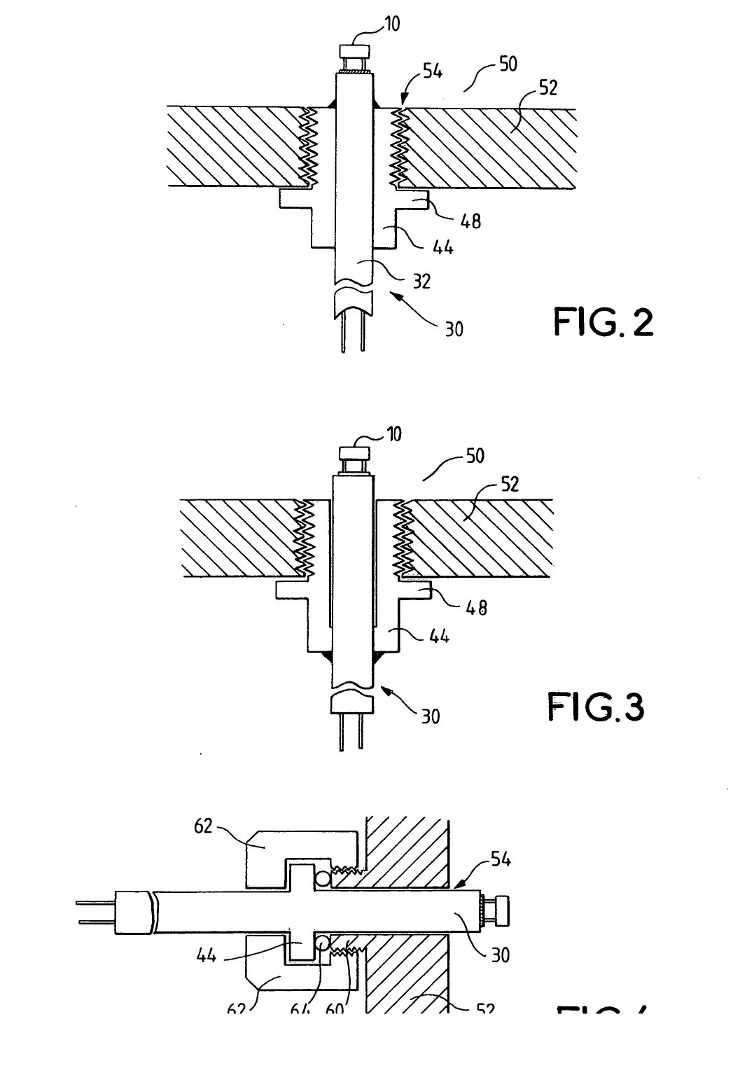

FIGS. 2 to 4 show examples of the sensor being mounted in a chamber, the cable passing through the wall of the chamber.

The cross section in FIG. 1 shows the assembly according to the invention. The actual sensor, a pressure sensor 10 in this example, is produced by micromachining, and preferably by micromachining an integrated circuit chip, comprising, altogether, pressure-sensitive mechanical components (a membrane 12 closing off a cavity 14), electrical detection components (strain gauges 16 on the membrane, outside or inside the cavity), interconnection conductors deposited and etched on the chip, input/output and supply and/or contact pads 18, also deposited and etched. Partial insulation of the conductors by one or more insulating layers 20 (made of silica, nitride, etc.) may also be provided, together with final passivation layers that are also insulating.

In this example, the chip consists of two adjoined wafers 22 and 24, allowing in particular the cavity and the membrane to be produced; the wafer 22 is made of silicon, while the wafer 24 may be made of silicon or glass for example. Other chip configurations are possible, for example those based on quartz or silicon carbide. For an accelerometer, there would not be a cavity closed off by a membrane, but rather a seismic mass linked by flexible arms. Instead of strain gauges, it is possible to have capacitors and resonant components.

The actual sensor, thus formed by the wafers 22 and 24 and the electrical components deposited on the wafer 22, is firmly attached to the end of a high-temperature cable, the attachment including an electrical connection between conductors of the cable and the contact pads 18.

To do this, the attachment is made by directly welding the ends of the cable conductors to the pads 18.

The high-temperature cable 30 essentially comprises a metal sheath 32 (for example made of stainless steel) enclosing a mineral insulation 34 resistant to high temperatures, especially a compacted mineral powder, which may be magnesia. Embedded in this insulation are electrical conductors 36 that project beyond the insulation outside the cable. The projecting ends of the conductors 36 are denoted by the reference 38. The sheath of the cable may be sealed off by an impermeable insulating layer 40 through which the ends 38 of the conductors pass. This layer must withstand high temperatures and may be made of glass or glass-ceramic, fitted by powder deposition and high-temperature reflow.

Typically, the conductors have a diameter of 0.3 mm and the stainless steel sheath 32 has an outside diameter of 2 mm, which shows how very compact the assembly is.

The ends of the conductors are welded directly to the pads 18 of the sensor. The welding is preferably electrolytic welding. This involves the deposition of metal or metals (metal alloys or deposition of several successive metals) on the conducting regions, this being obtained by the migration of metal ions coming from a liquid solution in which both the pads 18 and the ends 38 of the conductors are immersed while these ends are in electrical contact with the pads. The migration may be caused either by passing an electrical current (conventional electrolytic bath with current feed electrodes) or by a chemical reaction without a current supply (electroless deposition).

The spatial arrangement of the ends of the conductors is such that, when the sensor is brought up to the end of the cable 30, each end 38 comes into direct bearing contact (mechanical and electrical) with a respective contact pad 18 of the sensor.

The ends of the conductors are immersed into an electrolytic bath, while keeping them in contact with the pads that are also immersed into the bath, so that a conducting metal deposit forms, by electrolytic migration, both on the pads and on the ends of the conductors.

The electrolytic deposition operation (with or without an electrical current for producing the electrolysis) is continued until the thickness of deposited metal is sufficient to ensure rigid mechanical connection between each of the conductor ends and a corresponding pad of the sensor.

The metal is not deposited on the nonconducting parts, and this is why it is desirable for only the pads of this sensor to be stripped, the rest of the chip preferably being covered with a passivation layer.

The electrolytically deposited metal may in particular be copper or gold or nickel, but other metals are possible. Several metals may be deposited. A metal alloy or codeposit of two or more metals may also be envisioned. The connection pads may be made of gold or aluminum or of other metals or combinations of metals (sometimes several superposed metal layers). If the deposit is formed by conventional electrolysis by passing a current through a solution containing metal ions, arrangements are made to connect all the conductor ends 38 together during the period of the electrolysis (preferably via the other end of the cable, that is to say via a part that is not immersed in the electrolytic bath). A suitable electrolysis potential difference is applied between these conductors and another electrode immersed in the bath.

Electroless deposition is also possible; in this case, the electrolysis occurs by a simple chemical reaction between the conductors or contact pads and the ionic solution of the electrolytic bath, without an external potential difference being applied.

The thickness of the metal deposit on the pins may be a few tens of microns or more, in order to ensure a rigid mechanical weld between the conductors and the surface of the sensor.

The deposited metal covering the ends of the conductor that are immersed in the bath is denoted by the reference 42.

After electrolysis, it is desirable to cover the deposited metal with a passivation layer (not shown) made of a material resistant to high temperatures. The preferred solution is to carry out surface oxidation or nitriding of the metal. In one particular example, the metal electrolytically deposited in succession is copper and then tantalum, and the surface insulating layer is tantalum oxide, which is particularly resistant to moisture penetration, to the salinity of the air and to corrosive agents, even at high temperature. It is also possible to use fusible glass as passivation layer.

As will be seen later, it is preferable to provide for a second metal sheath 44 to very closely grip the first sheath 32, the second sheath serving as a seal when the cable is inserted into the feedthrough of a high-temperature chamber wall.

The second sheath 44 in this example is also made of stainless steel. It is welded or brazed to the first sheath around the periphery of the latter (the weld 46). The second sheath may include a flange 48 allowing the cable to bear against the wall of the chamber into which the sensor must penetrate. The second sheath may be threaded or provided with any desired means of attaching it to the wall of the chamber.

FIG. 2 shows a first example of how the assembly according to the invention for measuring a physical quantity (especially pressure) inside a high-temperature chamber 50 is mounted. The chamber is closed off by a wall 52 fitted with a feedthrough 54 through which the cable 30 may pass, the sensor chip 10 being welded to the end of said cable. The sensor is located in the chamber 50.

In this example, the feedthrough 54 is threaded. The metal sheath 32 of the cable is gripped by a second metal sheath 44 (as in FIG. 1), but this second sheath has an external thread suitable for screwing into the feedthrough. The second sheath is welded to the first, providing a seal between the sheaths. The cable/sensor assembly is fitted by introducing the sensor into the feedthrough and by screwing the cable into the feedthrough. The thread ensures that the chamber is sealed. The flange 48 (when it exists) may contribute to this sealing mechanism, an O-ring seal possibly being inserted between the flange and the wall of the chamber in order to make the sealing more effective.

In the example shown in FIG. 3, the assembly is mounted in exactly the same way. However, whereas in FIG. 2 the outer sheath 44 is welded to the inner sheath 32 on the inside of the chamber, in FIG. 3 the outer sheath is welded, on the contrary, to the inner sheath on the outside of the chamber; inside the chamber, the inner sheath is relatively free relative to the outer sheath on that side facing the inside of the chamber, thereby allowing better mechanical decoupling between the sensor and the points of attachment of the cable to the wall.

To improve decoupling, provision may also be made for the conductor ends of the cable to be long enough (for example 4 millimeters) and even to be of non-straight shape (forming a slight spring) so as to increase their flexibility with respect to movements of the sensor, thus preventing transmission to the active part of the sensor of excessive forces or undesirable vibrations, since, by its very nature, the active part is particularly sensitive to mechanical stresses (in particular in the case of a pressure sensor).

FIG. 4 shows an alternative mounting in which the cable is not screwed into the wall, rather it is screwed onto the wall 52 (for example onto a threaded protuberance 60 of the wall) a nut 62 that grips the cable in place in the feedthrough 54. The nut may press the flange 44, if its exists, against the wall or against the protuberance via a seal 64, thereby sealing it. The advantage is that the cable does not rotate during the screwing action, whereas it does rotate in the examples of FIGS. 2 and 3.

The invention is applicable not only to pressure sensors but to other types of sensor that can operate in a high-temperature environment (magnetometers, gyroscopes, accelerometers, gas detectors, etc.).

In the foregoing it was considered that the sensor is placed in a closed chamber separated from an open external environment. Of course, the chamber could be open, the external environment being closed. For example in the case of an application in oil drilling at great depth, the chamber would be the high-temperature high-pressure surrounding environment, the external environment to which measurement signals are sent by the cable being a sealed box containing processing electronics.

1. A method of mounting a sensor in a sealed manner in a wall feedthrough capable of being raised to a high temperature of around 200° C. or higher, the sensor being a micromachined sensor comprising at least one wafer provided with electrical connection pads, comprising the steps of:
connecting the sensor to the end of a cable resistant to this high temperature;
embedding the cable comprising several electrical conductors in an insulation that is held within a sheath;
passing the sheath through the wall feedthrough; extending the electrical conductors beyond the end of the sheath and being welded directly to the pads on the wafer; wherein the sheath is mounted in a sealed manner in the wall feedthrough.

2. The method as claimed in claim 1, wherein the sheath is a metal sheath and the insulation is a mineral insulation.

3. The method as claimed in claim 2, wherein the sheath is made of stainless steel.

4. The method as claimed in claim 2, wherein the insulation is a compacted oxide powder, especially magnesia powder.

5. The method as claimed in claim 1, wherein the conductors are welded to the pads by electrolytic welding.

6. An assembly formed from a sensor of a physical quantity and from a connection cable, comprising:
several electrical conductors embedded in an insulating material resistant to high temperatures; and
a metal sheath enclosing the conductors and the insulating material, this sheath also being resistant to high temperatures, the ends of the conductors extending beyond the insulating material at the end of the cable and being directly welded to supply contact and input/output pads on a micromachined chip forming the actual sensor.

7. The assembly as claimed in claim 6, wherein the metal sheath is itself surrounded, at the place that will correspond to the feedthrough in the wall of a chamber in which the physical quantity is measured, by another sheath tightly gripping the first sheath, the second sheath ensuring that the cable is mounted in a sealed manner in the wall feedthrough.
